(19) United States
(12) Patent Application Publication
(10) Pub. No.: US 2021/0201227 A1
(43) Pub. Date: Jul. 1, 2021

(54) SYSTEM AND PROCESS FOR CREATING A PROCESS FLOW CHART HAVING IMPRINTED ANALYTICS

(71) Applicant: Christopher J. Rozum, Cape Coral, FL (US)

(72) Inventor: Christopher J. Rozum, Cape Coral, FL (US)

(21) Appl. No.: 17/200,993

(22) Filed: Mar. 15, 2021

Related U.S. Application Data
(63) Continuation-in-part of application No. 15/671,232, filed on Aug. 8, 2017, now abandoned.

(51) Int. Cl. G06Q 10/06

(52) U.S. Cl. CPC G06Q 10/0633

(57) ABSTRACT

A system and process for creating and displaying a process flow chart wherein analytics are connected to and imprinted within a process flow chart next to an associated step within the subject process being visually displayed.

### CROSS-REFERENCE TO RELATED APPLICATIONS

This application is a continuation-in-part application of U.S. application Ser. No. 15/671,232, filed on Aug. 8, 2017, which is currently pending and from which the present application claims priority. The patent application identified above are incorporated herein by reference in their entirety to provide continuity of disclosure.

### FIELD OF THE INVENTION

This invention relates to process maps and more particularly to a system for tracking and collecting data relating to how a process is carried out, analyzing the collected data to produce analytics and transforming the collected data and analytics into a graphical display that illustrates breakdowns and opportunities for improvement within the process.

### BACKGROUND OF THE INVENTION

A process flow map or flow chart diagram is a type of diagram that represents an algorithm, workflow or process, showing the steps as boxes of various kinds, and their order by connecting them with arrows. Flow charts help visualize a process and to possibly identify flaws, bottlenecks, and other less-obvious features within it.

However, conventional flowcharts do not help to explain or understand the reasons why a process is breaking down. To do this, data within the process must be analyzed and the resulting analytics must be cross referenced with each step of a subject process to fully understand flaws located therein, causes of the flaws and how to fix them.

This requires cross referencing multiple documents and data from various systems to understand a set of findings supporting suggested changes in a process flow, thus eliminating the intended simplicity of the process flow map.

Therefore, a system for tracking and collecting data relating to how a process is carried out, analyzing the collected data to produce analytics and transforming the collected data and analytics into a graphical display that illustrates breakdowns and opportunities for improvement within the process.

### SUMMARY OF THE INVENTION

The primary object of the present invention is to provide a system for tracking and collecting data relating to how a process is carried out, analyzing the collected data to produce analytics and transforming the collected data and analytics into a graphical display that illustrates breakdowns and opportunities for improvement within the process.

The present invention fulfills the above and other objects by providing a system for creating and displaying a process flow chart wherein analytics are connected to and imprinted within a process flow chart next to an associated step within the subject process being visually displayed. This allows the reader to understand where a specific set of quantified analytics fits within a specific process step, thereby eliminating the need to search through multiple sets of documents to match analytics to specific points within the process flow chart.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a flow chart illustrating the steps for performing the system of the present invention and creating a process flow chart of the present invention in a computing environment;

FIG. 2 is an exemplary view of a process flow chart 201 of the present invention;

FIG. 3 is an exemplary view of a process flow chart of the present invention as illustrated referencing magnified portions of the process flow chart illustrated in FIGS. 4-5;

FIG. 4 is a magnified view of the process flow chart of the present invention within line 4-4 of FIG. 3; and

FIG. 5 is a magnified view of the process flow chart 201 of the present invention within line 5-5 of FIG. 3.

### DESCRIPTION OF THE PREFERRED EMBODIMENTS

The entire system and process of the present invention described herein and illustrated in the drawing figures are accomplished in a computer network environment using multiple computers and software technologies to drive the production of the process flowchart, known under the proprietary trademark of MegaMap.

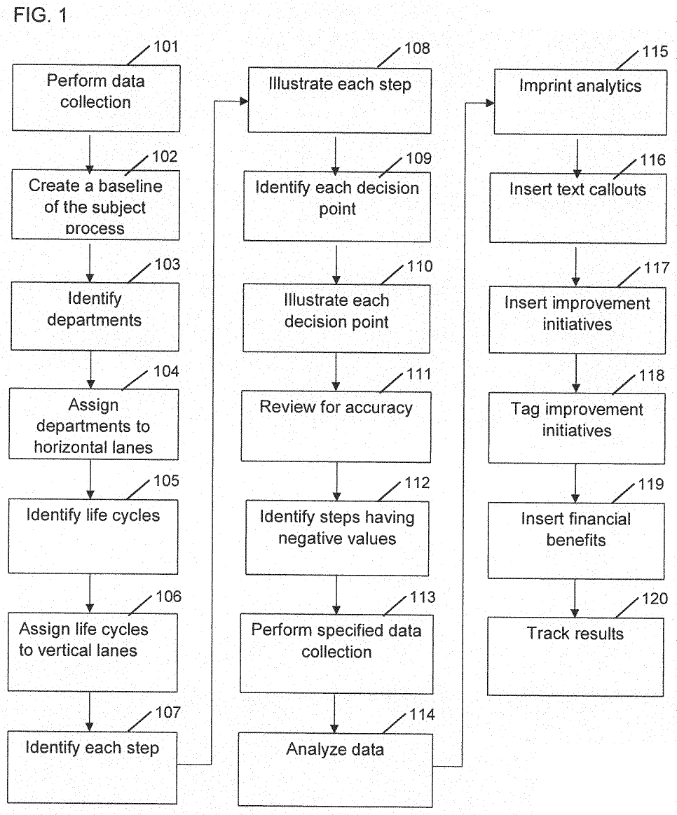

With reference to FIG. 1 a flow chart illustrating the steps for performing the system of the present invention and creating a process flow chart of the present invention in a computing environment is illustrated. First, data is collected to form a broad view of a process being analyzed or a subject process 101. Data may be collected electronically and/or manually through an observation process, wherein individuals' carrying out the subject process are observed to determine what steps and activities each individual performs throughout the subject process. This observation typically takes place within each individual's work environment and creates a statically meaningful sample to ensure the steps of the subject process are captured as each step is carried out and completed in real time. Data collection also includes the observation and collection of interaction flows, templates, use of systems within the flow, transactions or hand-offs between individuals performing steps within the subject flow, how assistance is requested and provided between individuals performing steps within the subject flow, how questions are worked within the flow, what reports are used within the flow, time required to perform steps performed within the flow, variations in how steps are performed within the flow, and so forth. UIPath® and Zoom® software are used in the collection of data on computers.

Then, a baseline is created using the collected data of how the subject flow currently is carried out and processed 102 wherein the collected data is confirmed and any inaccuracies or questions are clarified through individuals managing the subject process. Management steps may be determined, such as what reports are used to manage the process, how quality is verified, how ongoing training and/or development is approached and implemented. Obtaining microdata about a process includes transcribing audio recordings to text using artificial intelligence (AI) to identify tone and sentiment and time and motion details using software technology, such as ObserveAI@ and Excel®.

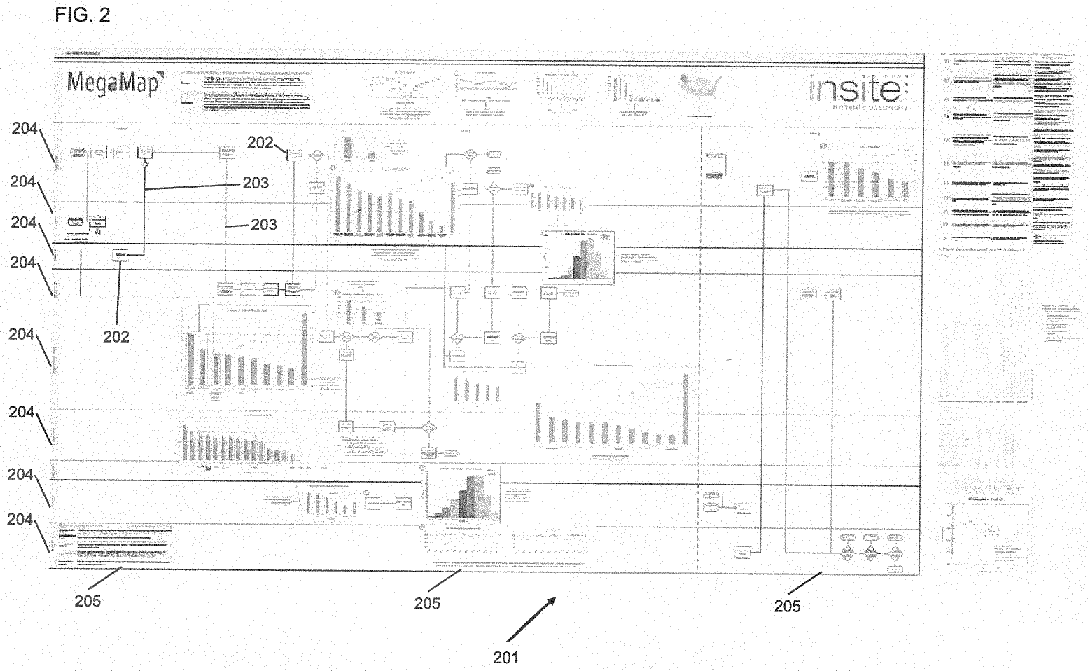

Next, departments involved in carrying out steps within the subject process are identified 103. Each department is assigned to a horizontal lane 104 defined on the process flow chart of the present invention, as illustrated in FIG. 2, specific steps carried out within the subject process may then be placed within a horizontal lane of the department which performs said steps.

Then, life cycles within the subject process are identified 105. For example, a process relating to customer experiences may comprise: A. customer acquisition, B. servicing acquired customers, and C. retaining acquired customers. Each stage in a life cycle is assigned to a vertical lane 106 defined on the process flow chart of the present invention, as illustrated in FIG. 2.

Next, each step within the subject process is identified 107 and illustrated 108 on the process flow chart of the present invention using a geometric symbol each containing a textual description of the step being illustrated. For example, rectangular-shaped boxes may be used for each action step wherein text within each box begins with a verb indicating an action being taken within the subject process. Decision points are also identified 109 and illustrated 110 using diamond-shaped boxes. Illustrated steps and decision points within the process flow chart of the present invention are preferably connected using lines and arrows to indicate directions and order of said steps and decision points within the subject process. Based on an output of a decision point, there may be multiple paths of subsequent action steps, as illustrated in FIG. 2. Said paths may be color coded to indicate preference levels of said paths. For example, a preferred path may be colored green or another “preferable” color and a less preferred path may be colored red. To create the visual illustration of the process steps so that such can be quickly modified as necessary, Visio® software is employed.

Then, the steps of the subject process illustrated in the process flow chart of the present invention are reviewed for accuracy 111 to ensure the subject process illustrated within the flow chart of the present invention is the most current representation of the subject process flow being presently implemented.

Next, each step identified within the process flow chart of the present invention is analyzed to identify negative values 112, such as weaknesses, variations, multiple hand-offs, unneeded steps, backlogs in inventory, rework, errors, low value activities, and so forth, to identify potential opportunities for improvement within the subject process. Steps identified as having negative values are then identified within the process flow chart with a visual identifier such as an icon or color coding.

Then, specified data collection is performed 113 for steps found to have a negative value wherein data is collected from various systems used to carry out the subject process, such as ACD, WFM, Quality, Speech Analytics Systems, HR Systems, Timeclock, CRM, data warehouse, and so forth. After the specified data collection is performed 113, a statistical analysis using run charts, bar charts, histograms, pareto charts, pie charts, multiple regression, correlation, erlang, algorithms, custom algorithms and so forth is performed 114 to produce one or more sets of analytics for each step having a negative value. Computers are used to create data analytics and visualization using Excel®, PowerBI® and MiniTab@ software.

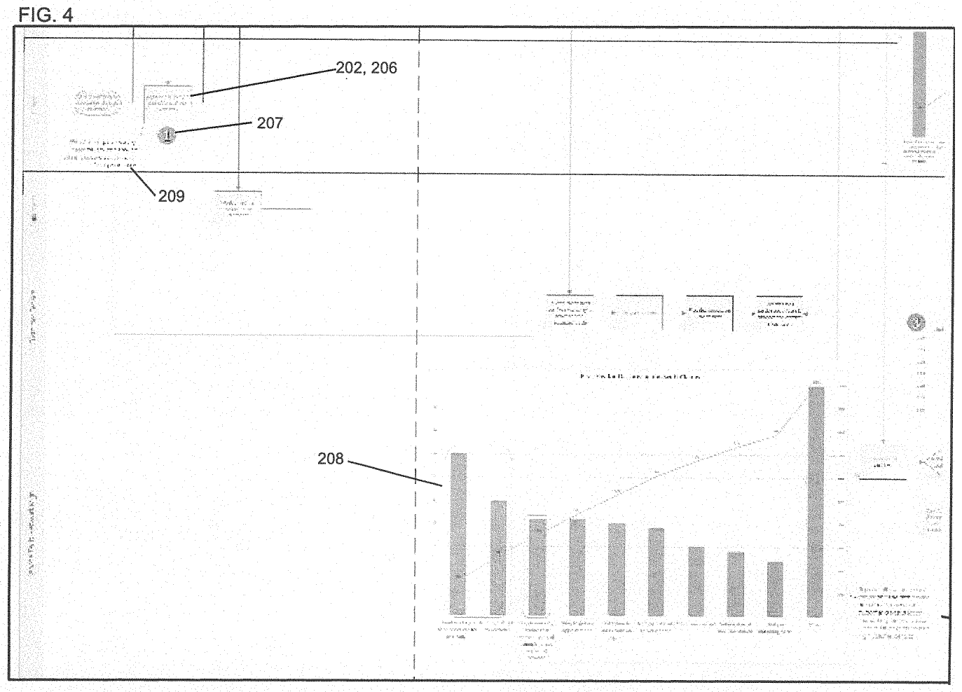

Next, the resulting analytics are imprinted within the process flow chart of the present invention 115 proximate to the associated step having a negative value for which statistical analysis was performed, as illustrated in FIG. 4.

Then, text callouts with the imprinted data analytics, which comprises interpretations and data sources, are inserted into the process flow chart of the present invention 116, as illustrated in FIG. 4. The callouts provide interpretations of the imprinted analytics. Adobe® and PowerPoint® software are used to create the illustrations to explain the concepts.

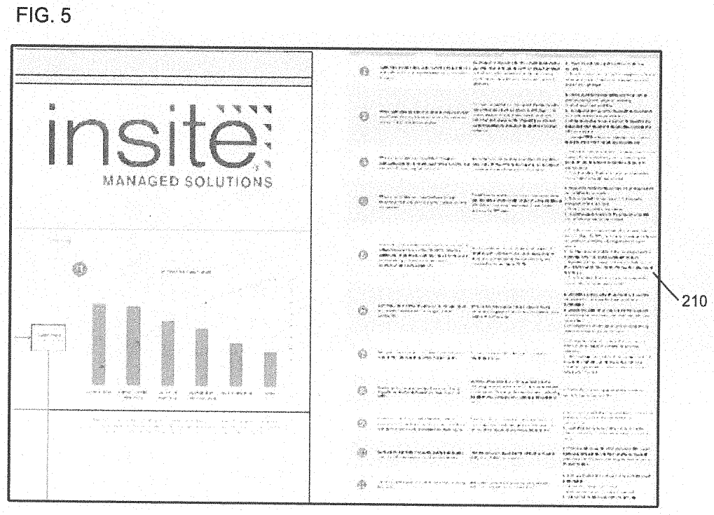

Next, improvement initiatives to correct steps identified as having negative values and are outlined within the process flow chart of the present invention 117, as illustrated in FIG. 5. The improvement initiatives are tagged or matched to corresponding steps using a visual indicator, such as numbering, lettering, symbols and so forth and/or color coding 118.

Then, financial benefits of carrying out each improvement initiative are calculated and inserted into the process flow chart of the present invention proximate to the corresponding improvement initiatives 119. This financial benefit calculator assists with prioritizing the improvement initiatives into a beneficial order in which to be carried out. Finally, as improvement initiatives are implemented, the results are tracked within the process flow chart of the present invention 120.

With reference to FIG. 2, an exemplary view of a process flow chart 201 of the present invention is illustrated. The process flow chart 201 of the present invention comprises a plurality of steps of a subject process represented within the process flow chart by using a geometric symbols 202, each containing a textual description of a step being illustrated. For example, rectangular-shaped boxes may be used for each action step wherein text within each box begins with a verb indicating an action being taken within the subject process. Decision points may be illustrated using diamond-shaped boxes or a variety of other shapes. Illustrated steps and decision points within the process flow chart of the present invention are preferably connected using lines and arrows 203 to indicate directions and order of said steps and decision points within the subject process. Based on an output of a decision point, there may be multiple paths of subsequent action steps. Said paths may be color coded to indicate preference levels of said paths. For example, a preferred path may be colored green or another “preferable” color and a less preferred path may be colored red.

Horizontal lanes 204 defined in the process flow chart 201 of the present invention divide departments involved in carrying out steps within the subject process.

Vertical lanes 205 defined in the process flow chart 201 of the present invention divide life cycles within the subject process.

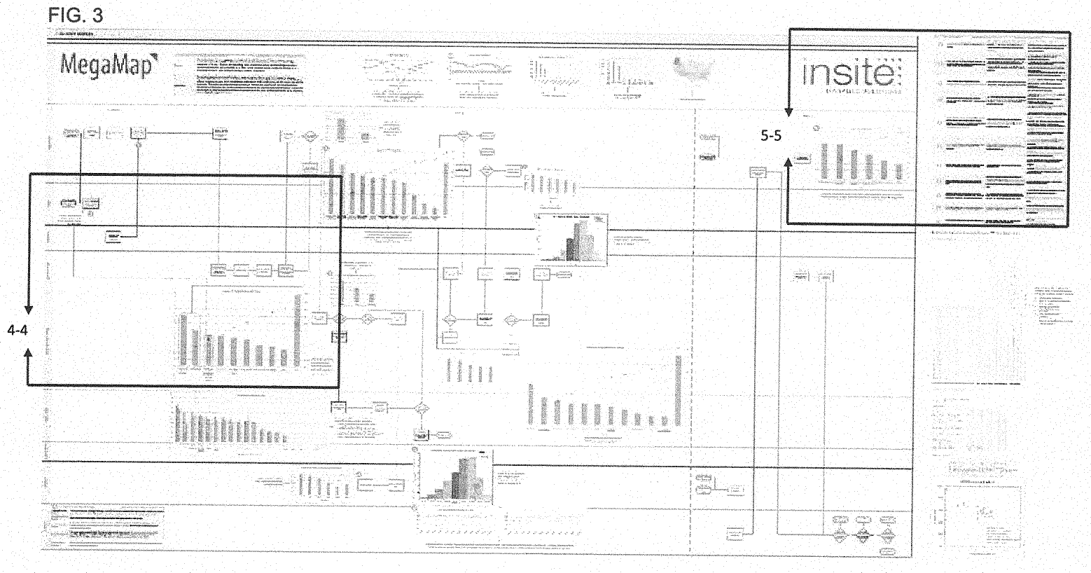

With reference to FIG. 3, an exemplary view of a process flow chart 201 of the present invention is illustrated referencing magnified portions of the process flow chart 201 illustrated in FIGS. 4-5.

With reference to FIG. 4, a magnified view of the process flow chart 201 of the present invention within line 4-4 of FIG. 3 is illustrated. At least one step identified as a negative value step 206 wherein improvements are required to carry out the step more efficiently is identified by a visual identifier 207 such as a negative step icon and/or color coding.

Analytics 208, such as a graph or equivalent visual representation of analyzed data, relating the negative value step is imprinted within the process flow chart 201 of the present invention proximate to the associated negative value step 206. Text callouts 209 are preferably located proximate to the imprinted data analytics 208 within the process flow chart 201 to provide interpretations of the imprinted analytics 208.

With reference to FIG. 5, a magnified view of the process flow chart 201 of the present invention within line 5-5 of FIG. 3 is illustrated. Improvement initiatives 210 to correct steps identified as having negative values and are outlined within the process flow chart 201 of the present invention. The improvement initiatives 210 are tagged or matched to corresponding steps using a visual identifier 207, such as numbering, lettering, symbols and so forth and/or color coding.

It is to be understood that while a preferred embodiment of the invention is illustrated, it is not to be limited to the specific form or arrangement of parts herein described and shown.

It will be apparent to those skilled in the art that various changes may be made without departing from the scope of the invention and the invention is not to be considered limited to what is shown and described in the specification and drawings.

Having thus described my invention, I claim:

1. A system for creating a process flow chart comprising:
a collection of data to form a broad view of a subject process being analyzed within a computing environment;
identification of a plurality of steps used to carry out the subject process using the collection of data within said computing environment;
each of the plurality of steps being analyzed to identify one or more steps having negative values within said computing environment;
an analysis of said collection of data to create a unique set of analytics for each step identified as having a negative value within said computing environment;
forming a visual representation within said computing environment;
said visual representation having an illustration of the plurality of steps within a process flow chart using geometric symbols each of which contain a textual description of a step being illustrated within said computing environment;
said geographic symbols within said visual representation being connected by a plurality of arrows to indicate an order in which the plurality of steps are carried out within the subject process;
each unique set of analytics being imprinted within the said visual representation proximate to at least one of the geographic symbols used to illustrate a step having a negative value;
an identification within said computing environment of one or more departments involved in carrying out the plurality of steps within the subject process;
a matching within said computing environment of steps each identified department is responsible for carrying out;
outlining improvements initiatives to correct steps as having negative values within the process flow chart;
calculating the financial benefits of carrying out each improvement initiative;
horizontal lanes defined in said visual representation of the flow chart within said computing environment dividing departments identified as involved in carrying out steps within the subject process;
a separation of the plurality of steps within the subject process into one or more life cycles in said visual representation of the flow chart within said computing environment;
an assignment of each life cycle to one or more vertical lanes within said visual representation of the flow chart within said computing environment; and
said one or more vertical lanes defined in said visual representation of the flow chart within said computing environment dividing said life cycles within the subject process.

2. A flow chart comprising:
a visual representation of a collection of data forming a broad view of an analyzed subject process;
said visual representation showing a plurality of steps used to carry out the subject process using the collection of data;
said plurality of steps being represented within said visual representation via geometric symbols, each of said geometric symbols containing a textual description of a step being illustrated therein;
said geographic symbols being connected by a plurality of arrows within said visual representation to indicate an order in which the plurality of steps are carried out within the subject process;
a negative value relating to at least one of said plurality of steps being identified within the visual representation of said flow chart;
an analysis of said collection of data to create a unique set of analytics for each step identified as having a negative value;
a unique set of analytics being imprinted within said visual representation of said flow chart proximate to said at least one step identified as having a negative value;
improvement initiatives to correct steps identified as having negative values, said improvement initiatives being matched to corresponding steps using a visual identifier;
a calculation of financial benefits of carrying out each improvement initiative; and
two or more horizontal lanes defined in said visual representation of the flow chart dividing said life cycles within the subject process.

3. A process for creating a process flow chart comprising:
collecting data to form a broad view of a subject process being analyzed within a computing environment;
identifying a plurality of steps used to carry out the subject process using the collection of data within said computing environment;
analyzing each of the plurality of steps to identify one or more steps having negative values within said computing environment;
analyzing said collection of data to create a unique set of analytics for each step identified as having a negative value within said computing environment;
forming a visual representation within said computing environment;
said visual representation having an illustration of the plurality of steps within a process flow chart using geometric symbols each of which contain a textual description of a step being illustrated within said computing environment;
said geographic symbols within said visual representation being connected by a plurality of arrows to indicate an order in which the plurality of steps are carried out within the subject process;
each unique set of analytics being imprinted within the said visual representation proximate to at least one of the geographic symbols used to illustrate a step having a negative value;
identifying within said computing environment of one or more departments involved in carrying out the plurality of steps within the subject process;
matching within said computing environment of steps each identified department is responsible for carrying out;
outlining improvements initiatives to correct steps as having negative values within the process flow chart;
calculating the financial benefits of carrying out each improvement initiative;
defining by horizontal lanes in said visual representation of the flow chart within said computing environment dividing departments identified as involved in carrying out steps within the subject process;
separating the plurality of steps within the subject process into one or more life cycles in said visual representation of the flow chart within said computing environment;
assigning of each life cycle to one or more vertical lanes within said visual representation of the flow chart within said computing environment; and
defining by said one or more vertical lanes in said visual representation of the flow chart within said computing environment dividing said life cycles within the subject process.
